(19) United States
(12) Patent Application Publication
(10) Pub. No.: US 2013/0254354 A1
(43) Pub. Date: Sep. 26, 2013

(54) ELECTRONIC INFORMATION TERMINAL AND ELECTRONIC INFORMATION SYSTEM

(71) Applicants: Ikue Kawashima, Kanagawa (JP); Mayuka Araumi, Tokyo (JP)

(72) Inventors: Ikue Kawashima, Kanagawa (JP); Mayuka Araumi, Tokyo (JP)

(21) Appl. No.: 13/993,785

(22) PCT Filed: Dec. 5, 2011
(86) PCT No.: PCT/JP2011/078631

§ 371 Date: Jun. 13, 2013

(30) Foreign Application Priority Data
Dec. 28, 2010 (JP) 2010-293963

(51) Int. Cl. H04L 29/08

(52) U.S. Cl. CPC H04L 67/10
USPC 709/219

(57) ABSTRACT

An electronic information terminal in communication with a server includes either an appropriateness determination unit or a transmission and receiving unit, and a next page instruction unit. Further, when the next page instruction unit instructs to display a next page, the appropriateness determination unit determines whether input data to a standard menu of the terminal are appropriate or the transmission and receiving unit transmits the input data to the server and receive an appropriateness determination result of the input data from the server.

### TECHNICAL FIELD

The present invention relates to an electronic information terminal and an electronic information system.

### BACKGROUND ART

Recently, paperless operations have become more popular in a document exchange field of, for example, filing various applications to public institutions, general companies and the like. Namely, conventional communications using paper medium is being replaced by using electronic information. To that end, various electronic information communication methods such as methods using, for example, various groupware, e-mail, WEB browser, and APS (Active Server Page) have been proposed and put into practice.

As a practical example of the paperless, electronic information terminals having a display, which may be called a display having a memory function or a non-volatile display, have been widely used. Further, electronic information systems for, for example, registering customer information using the electronic information terminal have been developed. Generally, the electronic information terminal includes a main controller collectively controlling the entire apparatus, a storage for storing various data and programs, a display section of the display described above, an input section allowing direction input on the screen using an input means such as a digitizer pen as described in, for example, Patent Documents 1 and 2, and a communication controller establishing a communication network with a server.

As an information input method using such a electronic information terminal, there has been known a method as described in Patent Document 3. In the method of Patent Document 3, a standard format of the application of a credit card and the like is displayed page by page on the display of the display section, so that information items such as name, address, phone number and the like can be input to the pages of the application. As a result, an input operation of registering customer information to the server can be conducted. When all input operations to all the pages are completed, a data transmission button is pressed so that the entire input data are collectively transmitted to the server. Then, the server performs an appropriate check by determining whether all the necessary information has been properly input and whether the input data are appropriate. When detecting inappropriate information data, the checked result is transmitted to the electronic information terminal, so that a message prompting the re-entry of information for correction is displayed on the display section. Then, the information data of the entire page including the re-entered information is transmitted to the server again, so that the server performs the appropriate check. When determining that the information is appropriate, the information data of all the pages are stored in the storage of the server or the electronic information terminal and the application operation is completed.
Patent Document 1: Japanese Laid-Open Patent Application No. 2006-139643
Patent Document 2: Japanese Laid-Open Patent Application No. 2007-279961
Patent Document 3: Japanese Laid-Open Patent Application No. 2008-015864

### DISCLOSURE OF THE INVENTION

### Problems to be Solved by the Invention

However, in the method of Patent Document 3, the input data of all the pages are transmitted to the server via a network, and this transmission of the input data of all the pages is repeated until when determining that all the input data are appropriate. Because of this feature, the workloads of the server and the network may be increased. Further, it may not be determined whether there is an input error until the server performs the appropriate check on the input data of all the pages transmitted from the electronic information terminal and the result of the appropriate check is transmitted to the electronic information terminal. Further, in a case where there are a wide variety of the input items, if the error message is transmitted from the server, it may be difficult for an operator to locate the input data to be corrected. As a result, the operator may have to review the information data one by one from the beginning, which may render the operations cumbersome and complicated.

The present invention is made in light of the above problems, and may reduce the workloads of the server and the network and provide an electronic information terminal and an electronic information system having improved operability.

### Means for Solving the Problems

To that end, according to a first aspect of the present invention, an electronic information terminal includes a main controller collectively controlling the entire electronic information terminal, a storage, a display unit, an input unit, and a communication controller establishing a communication network with a server. Further, the electronic information terminal includes either an appropriateness determination unit or a transmission and receiving unit, the appropriateness determination unit determining whether input data are appropriate, the input data being input by the input unit and corresponding to an input item of a standard format, the transmission and receiving unit transmitting the input data to the server and receiving an appropriateness determination result of the input data from the server; a next page instruction unit instructing to display a next page of the standard format including one or more pages; and a data transmission instruction unit instructed to transmit the input data to the server using the communication controller. Further, when the next page instruction unit instructs to display the next page, either the appropriateness determination unit determines whether all the input data are appropriate, the input data being displayed on a screen in a page of the standard format, or the transmission and receiving unit transmits the input data to the server and receives the appropriateness determination result of the input data from the server, so that, when determining that all the input data displayed on the page are appropriate, the next page is displayed if the next page is available. Further, when there is no next page and the next page instruction unit instructs to display the next page, either all the input data of all the pages are transmitted to the server and data input to the standard format is completed, the input data having been determined as appropriate by the appropriateness determination unit, or the input data corresponding to the input items of the page displayed on the display unit when the next page instruction unit instructs to display the next page are transmitted to the server by the transmission and receiving unit and when determining that the input data are appropriate based on the appropriateness determination result received from the server, data input to the standard format is completed.

Further, according to a second aspect of the present invention, the electronic information terminal according to the first aspect includes the appropriateness determination unit determining whether input data are appropriate, the input data being input by the input unit and corresponding to the input item of the standard format, the transmission and receiving unit transmitting the input data to the server and receiving the appropriateness determination result of the input data from the server, and a determination unit determining whether the input data are to be determined whether the input data are appropriate using the appropriateness determination unit or the input data are to be transmitted to the server by the transmission and receiving unit so that the appropriateness determination result of the input data is received from the server.

Further, according to a third aspect of the present invention, an electronic information terminal including a main controller collectively controlling the entire electronic information terminal, a storage, a display unit, an input unit, and a communication controller establishing a communication network with a server. The electronic information terminal includes an appropriateness determination unit determining whether input data are appropriate, the input data being input by the input unit and corresponding to an input item of a standard format, a transmission and receiving unit transmitting the input data to the server and receiving an appropriateness determination result of the input data from the server; a next page instruction unit instructing to display a next page of the standard format including one or more pages; and a data transmission instruction unit instructing to transmit the input data to the server using the communication controller. Further, when the next page instruction unit instructs to display the next page, the appropriateness determination unit determines whether all the input data are appropriate, the input data being displayed on a screen in a page of the standard format, or when the appropriateness determination unit cannot determine whether the input data are appropriate, the input data are transmitted to the server by the transmission and receiving unit and the appropriateness determination result of the input data is received from the server, so that, when determining that all the input data displayed on the page are appropriate, the next page is displayed if the next page is available. Further, when there is no next page and the next page instruction unit instructs to display the next page, all the input data of all the pages are transmitted to the server and data input to the standard format is completed, the input data having been determined as appropriate by the appropriateness determination unit, and when the appropriateness determination unit cannot determine whether the input data are appropriate, the input data corresponding to the input item of the page displayed on the display unit when the data transmission instruction unit instructs to transmit the input data, the input data are transmitted to the server by the transmission and receiving unit, and when determining that the input data are appropriate based on the appropriateness determination result received from the server, the data input to the standard format is completed.

Further, according to a fourth aspect of the present invention, the electronic information terminal according to the third aspect, further includes a determination unit determining whether the input data to be determined are appropriate using the appropriateness determination unit or the input data to be transmitted to the server by the transmission and receiving unit so that the appropriateness determination result of the input data is received from the server.

Further, according to a fifth aspect of the present invention, there is provided the electronic information terminal according to the second or the fourth aspect, in which the determination unit determines whether the input data are appropriate, to be performed by the appropriateness determination unit when the input data corresponds to inspection data and that the input data are transmitted to the server so that the appropriateness determination result of the input data is received from the server.

Further, according to a sixth aspect of the present invention, there is provided the electronic information terminal according to the fifth aspect, in which the inspection data corresponds to data having a relatively small data amount or data on which an easy process is performed of determining whether data are input, determining whether a check mark is placed, whether the number of check marks exceeds a predetermined number, or whether a character type of the input data is appropriate.

Further, according to a seventh aspect of the present invention, there is provided the electronic information terminal according to the fifth aspect in which the attached data corresponds to data having a relatively large data amount or data on which a complicated process is performed of determining appropriateness of image data including handwriting characters, stroke data including handwriting characters, the input data outside of a column, image data including an input symbol, or date data.

Further, according to an eighth aspect of the present invention, there is provided the electronic information terminal according to any one of the first through the seventh aspects, in which when a determination result by the appropriateness determination unit and the appropriateness determination result received by the transmission and receiving unit indicate that the input data are not appropriate, the display unit is configured to display an error message.

Further, according to a ninth aspect of the present invention, the electronic information terminal according to the first or the third aspect, further includes an essentiality determination unit configured to determine whether the input item is necessary to be filled with data when data corresponding to an input item of the standard format are not input and either the next page instruction unit instructs to display the next page or the data transmission instruction unit instructs to transmit the input data. Further, when the essentiality determination unit determines that the input item is necessary to be filled with data, the display unit is configured to display a message requesting data input to the input item.

Further, according to a tenth aspect of the present invention, there is provided the electronic information terminal according to the first or the third aspect, in which the data transmission instruction unit transmits the input data in a case where the next page instruction unit instructs to display the next page or the data transmission instruction unit instructs to transmit the input data based on the instruction to display the next page or the instruction to transmit the input data, respectively, when an instruction to select an option not to input data is input to a predetermined column indicating whether data corresponding to the input item is input or when an instruction to select an option to input data is input into a predetermined column and the corresponding data are input and determined that the corresponding data are appropriate by the appropriateness determination unit or it is determined that the input data are appropriate based on the appropriateness determination result received from the server by the transmission and receiving unit.

Further, according to an eleventh aspect of the present invention, there is provided the electronic information terminal according to any one of the first through the tenth aspects, in which when the input data correspond to personal data, the input data are stored in the storage or transmitted to the server by the communication controller, and the input data are deleted from the display unit.

Further, according to a twelfth aspect of the present invention, there is provided the electronic information terminal according to any one of the first through the eleventh aspects, in which the display section includes a display having a memory function.

Further, according to a thirteenth aspect of the present invention, there is provided the electronic information terminal according to any one of the first through the twelfth aspects, in which the display unit inputs handwriting data.

Further, according to a fourteenth aspect of the present invention, an electronic information system includes the electronic information terminal according to any one of the first through thirteenth aspects; and a server in communication with the electronic information terminal with a network.

In an embodiment of the present invention, when the next page instruction unit instructs to display the next page, the appropriateness determination unit determining whether all the input data input to the corresponding input displayed on the display unit page by page are appropriate or the transmission and receiving unit transmits the input data to the server and receives the appropriateness determination result of the input data from the server. Further, when determining that all the input data in the displayed page is appropriate, the next page is displayed. Further, when it is determined that all the input data of all the pages are appropriate and the data transmission instruction unit instructs to transmit all the input data having been determined as appropriate to the server, the input data having been determined as appropriate by the appropriateness determination unit are transmitted to the server by the communication controller, and the data input to the standard format is completed. Otherwise, the input data in the page displayed when data transmission instruction unit instructs to transmit the input data are transmitted to the server by the data transmission instruction unit and the appropriateness determination result indicating that the input data are appropriate are received, the data input to the standard format is completed. Further, when the appropriateness determination unit determines whether the input data are appropriate (i.e., performs the appropriate check) page by page, the input data of the page having the input data having been determined as appropriate are not transmitted to the server. Because of this feature, the amount of all the input data that has been determined as appropriate by the appropriateness determination unit and that has been collectively transmitted to the server is less than the total data amount of the input data when the input data are transmitted to the server. The input data including the input data having been determined as appropriate and the input data to be determined whether the input data are appropriate by the server in a case where the appropriate check is performed by the server for the transmitted data amount of the input data having been already determined as appropriate. Similarly, when the input data are transmitted to the server and the server determines whether the input data in the pages are appropriate, the input data having been determined as appropriate already are not transmitted to the server. By doing this, the total data amount of data transmitted to the server is less than the data amount of the input data including the input data having been determined as appropriate and the input data on which the appropriate check is performed by the data amount of the input data that has been determined as appropriate and that are not transmitted to the server. As described above, the data amount of the data transmitted and received between the electronic information terminal and the server may be reduced. As a result, it may become possible to reduce the workloads of the server and the network. Further, the appropriate check to determine whether the input data are appropriate is performed page by page. Therefore, for example, an error message may be displayed page by page. As a result, it may become possible to check the corrected input data and the column where the input data are to be corrected. Therefore, it may become easier to correct erroneous input data and improve the operability.

### Effects of the Present Invention

According to the present invention, it may become possible to reduce the workloads of the server and the network and improve the operability.

### BRIEF DESCRIPTION OF THE DRAWINGS

FIG. 1 is a perspective view illustrating a configuration of an electronic information terminal according to an embodiment of the present invention;

FIG. 2 is a schematic view of a configuration of an electronic information system;

FIG. 3 is a schematic view of an input operation of the electronic information terminal according to the embodiment of the present invention;

FIG. 4 is a flowchart of the input operations of the electronic information terminal;

FIG. 5 is a schematic view of another input operation of the electronic information terminal according to the embodiment of the present invention;

FIG. 6 is a flowchart of the input operation of the electronic information terminal of FIG. 5;

FIG. 7 is a schematic view of still another input operation of the electronic information terminal according to the embodiment of the present invention;

FIG. 8 is a flowchart of the input operation of the electronic information terminal of FIG. 7;

FIG. 9 is a schematic view of still another input operation of the electronic information terminal according to the embodiment of the present invention;

FIG. 10 is a flowchart of the input operation of the electronic information terminal of FIG. 9;

FIG. 11 is a schematic view of still another input operation of the electronic information terminal according to the embodiment of the present invention;

FIG. 12 is a flowchart of the input operation of the electronic information terminal of FIG. 11; and

FIG. 13 is a schematic view of still another input operation of the electronic information terminal according to the embodiment of the present invention.

### DESCRIPTION OF THE REFERENCE NUMERALS

10, 10-1˜10-n: Electronic Information Terminal
11: Display
12: Next Page Button
13: Previous Page Button
14: Data Transmission Button
15: Next Page Display Button
16: Data Transmission Display Button
30-1˜30-m: Server

### BEST MODE FOR CARRYING OUT THE INVENTION

In the following, an electronic information terminal according to an embodiment of the present invention is described in detail with reference to the drawings.

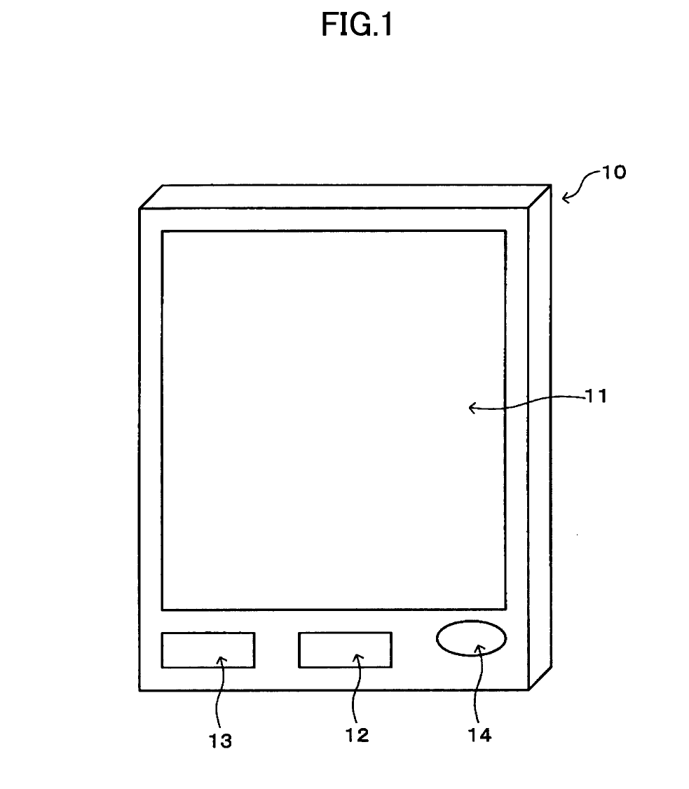

FIG. 1 is a perspective view of the electronic information terminal in this embodiment. An electronic information terminal 10 in FIG. 1 includes a display 11, a next page button 12, a previous page button 13, and a data transmission button 14 as main elements. The display 11 displays a standard format, various buttons such as a next page display button and a previous page display button described below, an error message, a guide message and the like. Further, data may be input by touching the screen of the display. Further, data may be input by hand writing using a digitizer pen and the like. The next page button 12 is used to display (go to) the next page when available. The previous page button 13 is used to display (go back to) the previous page (when available). The data transmission button 14 is used to transmit input data to be stored in a server. The display 11 of the electronic information terminal 10 is made of, for example, a display having a memory function or a non-volatile display. The display having the memory function and the non-volatile display memorize the data of the displayed screen so as to (continuously) display the memorized data without requiring a power supply. The electronic information terminal 10 further includes a memory (not shown) for storing various programs, a CPU (not shown) for processing input data when the input data can be processed by the terminal and collectively controlling the entire elements of the terminal, and an interface (not shown) for connecting with a network to establish a communication line with the server.

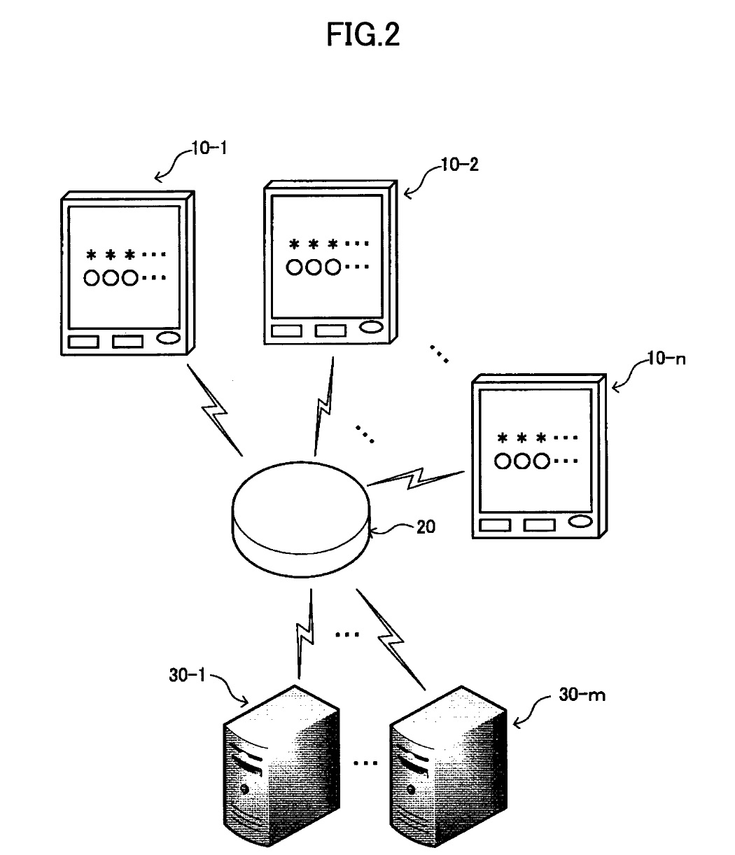

FIG. 2 illustrates an electronic information system including the electronic information terminal 10 and the server connected with the electronic information terminal 10 via a network. As illustrated in FIG. 2, there may be plural electronic information terminals 10-1 to 10-n (n: a positive integer) that may be connected with at least one or more servers 30-1 to 30-m (m: a positive integer). When the input data input to the electronic information terminals 10-1 to 10-n are attached data (e.g., handwriting signature data) described below, the input data are transmitted from the electronic information terminals 10-1 to 10-n to the servers 30-1 to 30-m, so that the servers 30-1 to 30-m perform processes and appropriate checks on the received attached data (input data). In this case, depending on the amount of the attached data or degree of importance, the workload of the processes and the appropriate checks may be distributed among the servers 30-1 to 30-m.

Further, in this embodiment, the data of the input data on which the appropriate check is performed are classified into two types of data: the inspection data and the attached data. The amount of the inspection data is relatively small, so that the inspection data can be processed easily. On the other hand, the amount of the attached data is relatively large, so that the process performed on the attached data may be complicated. The inspection data include, for example, the data indicating whether data are input to the predetermined column, the data indicating whether a check mark is placed, the data indicating whether the number of the check marks exceeds a predetermined limit number, and the data indicating whether the input data are recognizable characters, figures, or symbols. The attached data include, for example, the image data including handwriting characters, the stroke data (e.g., writing direction and writing pressure) of handwriting characters, the data indicating the position where the check mark is placed (i.e., data indicating whether the check mark is placed in a predetermined column or in another area), the image data of the characters and symbols written outside a predetermined column, the data indicating date when data are written in columns, the data indicating the postal code to be used for searching for the address.

An example input operation using the electronic information terminal in this embodiment is described.

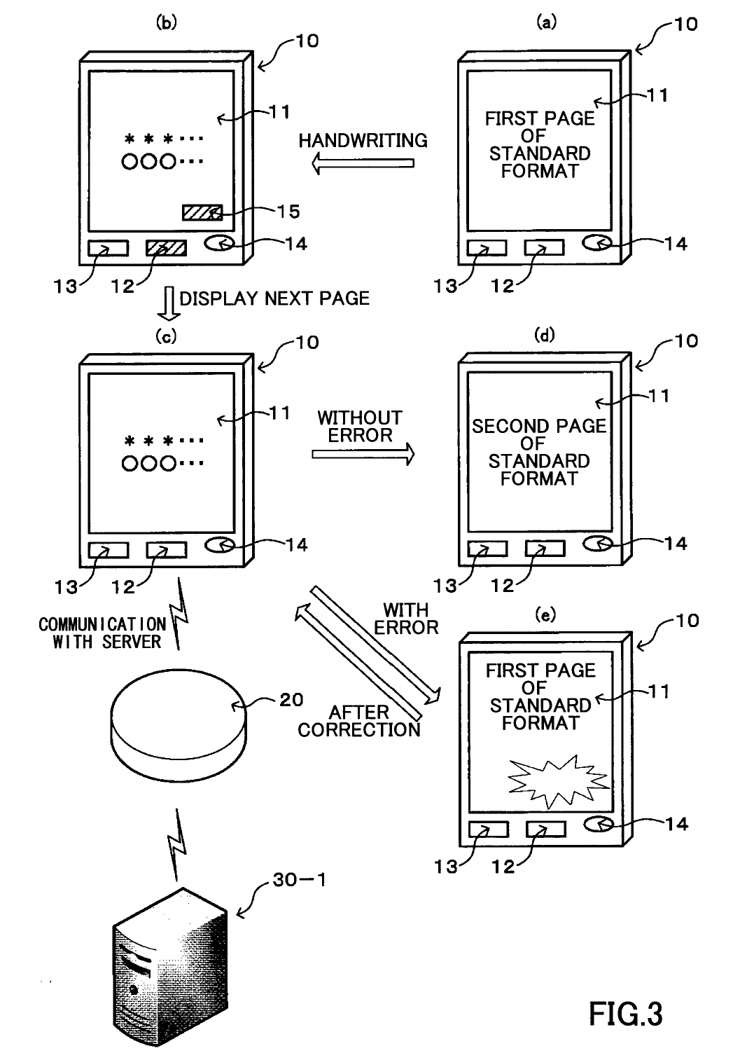

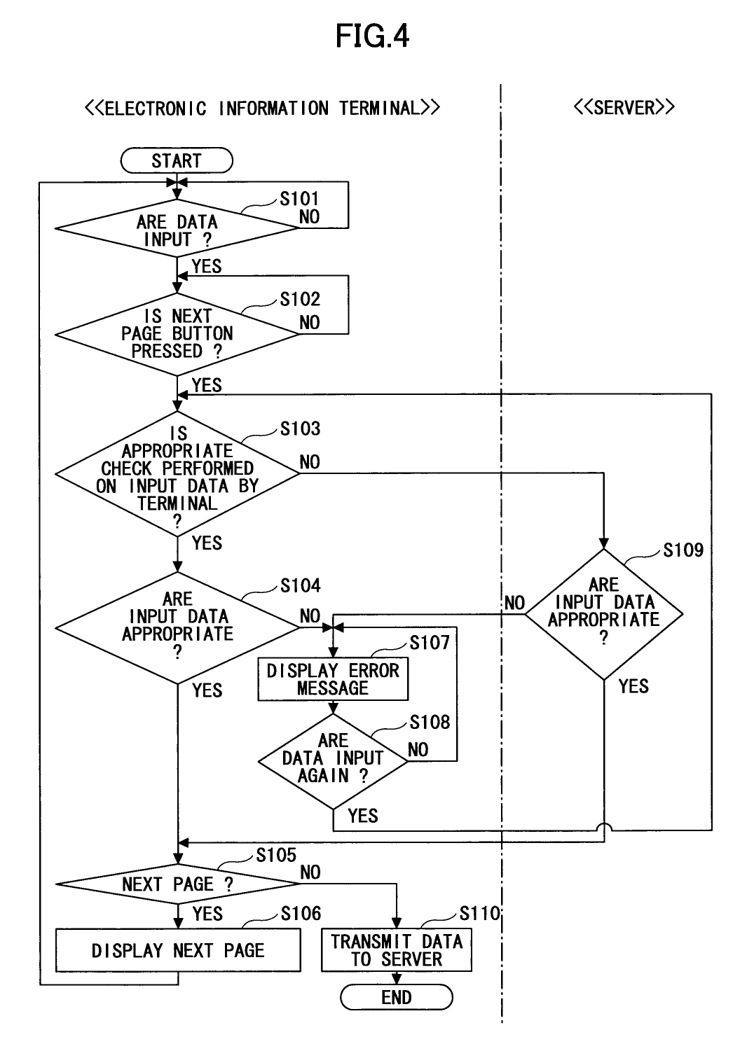

FIG. 3 schematically illustrates an input operation of the electronic information terminal in this embodiment. FIG. 4 is a flowchart of the input operation of FIG. 3. First, as illustrated in part (a) of FIG. 3, the display 11 of the electronic information terminal 10 displays the first page of a standard format. Herein, a case is described where handwriting data are input to the first page of the standard format as input data. In this case, the electronic information terminal 10 monitors (determines) whether the handwriting data are input (written) in a predetermined column using a pen input means (not shown) (step S101). Then, as illustrated in part (b) of FIG. 3, when determining that the handwriting data are input (YES in step S101), the electronic information terminal 10 further determines whether the next page button 12 or a next page display button 15 displayed on the display 11 to be operated is pressed (touched) (step S102). When determining that the next page button 12 or a next page display button 15 is pressed (YES in step S102), the electronic information terminal 10 further determines whether the electronic information terminal 10 performs the appropriate check on the input data (step S103). In this case, when determining that the appropriate check can be performed based on a simple criterion, the electronic information terminal 10 determines to perform the appropriate check by the electronic information terminal 10 without transmitting the input data to the server 30-1. By doing this, it may become possible to reduce the workload of the network and eliminate transmission time to and the processing time in the server 30-1. As a result, it may become possible to complete the processing stage in a short time period and reduce the degradation of the operability. Further, the input data may be processed in the electronic information terminal 10 regardless of the amount of the input data or the complexity of the process.

Then, when determining that the appropriate check is to be performed by the electronic information terminal 10 (YES in step S103), the electronic information terminal 10 performs the appropriate check to determine whether the input data are appropriate (step S104). When determining that the input data are appropriate (YES in step S104), the electronic information terminal 10 determines whether the next page is available (step S105). When determining that the next page is available (YES in step S105), the electronic information terminal 10 displays the next page (step S106), and the process goes back to step S101. The appropriate check herein refers to the check that can be performed based on a simple criterion. For example, the check includes to determine whether the handwriting data are written in a predetermined column and determines whether the handwriting characters are recognizable. On the other hand, when determining that the input data are not appropriate (NO in step S104), an error message is displayed on the display 11 to request appropriate data input (step S107). After that, the error message is displayed until the next handwriting data are input (NO in step S108). When the next handwriting data are input (YES in step S108), the process goes back to step S103 and it is determined whether the input data input in step S108 is appropriate. In this case, after the next handwriting data are input (YES in step S108), the process may go back to step S104 to perform the appropriate check. Referring back to step S103, when determining that the electronic information terminal 10 cannot perform the appropriate check on the input data by the electronic information terminal 10, specifically when the handwriting input data are image data including handwriting characters, the electronic information terminal 10 establishes the connection with the server 30-1 via the network 20 and transmits the input data to the server 30-1 (NO in step S103). Then, the server 30-1 performs the appropriate check, and transmits the result of the appropriate check to the electronic information terminal 10 (step S109). Upon the receipt of the result of the appropriate check, the electronic information terminal 10 performs the processes similar to the processes in steps S105 and S106 described above. When determining that there is no next page available in the standard format (NO in step S105), the input data of all the pages are collectively transmitted to the server, and the data input to the standard format is completed (step S110). It is assumed that the input data are collectively transmitted to the server when the data transmission button 14 is pressed or when determining that all the input data are appropriate until the last page.

Next, another input operation is described. This input operation includes a process determining whether the input item is necessary (essential).

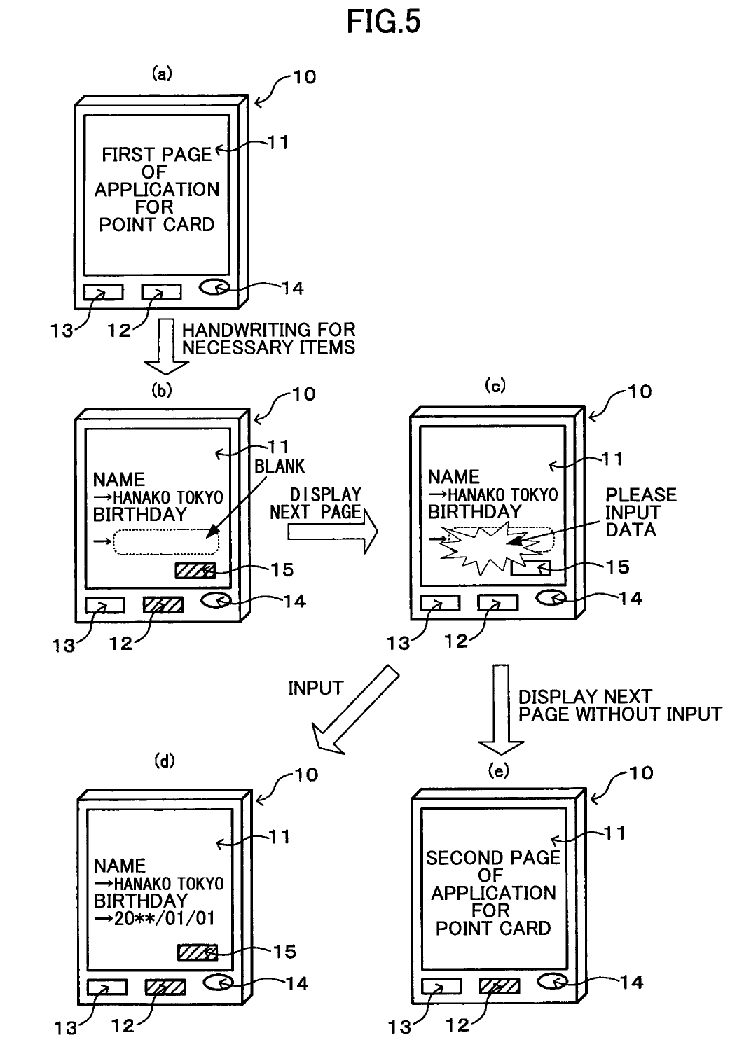

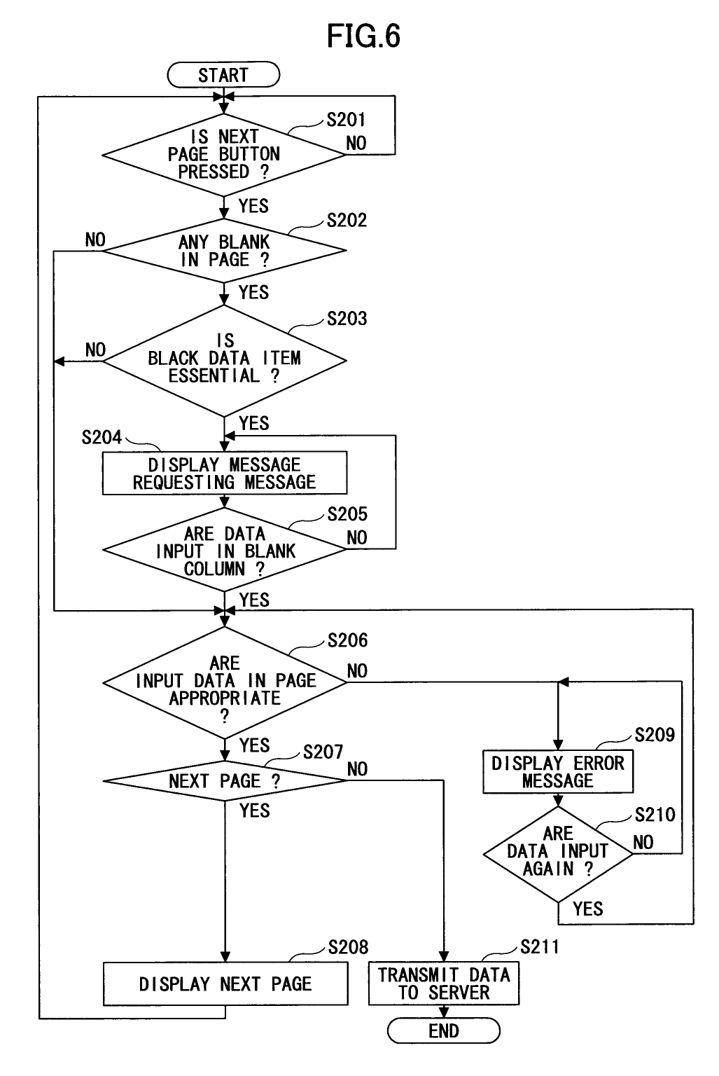

FIG. 5 schematically illustrates another input operation of the electronic information terminal in this embodiment. FIG. 6 is a flowchart of the input operation of FIG. 5. First, as illustrated in part (a) of FIG. 5, the display 11 of the electronic information terminal 10 displays the first page of a standard format. In this example, a standard format of an application of a point card is described. In the first page of the standard format, there are columns for inputting the name and the birthday. In this example, the electronic information terminal 10 does not monitor (determine) whether handwriting data are input (written) in the predetermined column using the pen input means (not shown). Namely, as illustrated in part (b) of FIG. 5, the electronic information terminal 10 determines whether the next page button 12 or the next page display button 15 on the display 11 to be operated is pressed (touched) (step S201). When determined that the next page button 12 or the next page display button 15 is pressed (YES in step S201), the electronic information terminal 10 further determines whether there is a blank column remaining in the page (step S202). As a result, when determining that there is a blank column (YES in step S202), the electronic information terminal 10 further determines whether the input item of the blank column is necessary to be input (step S203). When determining that the input item of the blank column is necessary to be input (YES in step S203), a message is continuously displayed until data are input into the blank column (step S204 and NO in step S205). When data are input into the blank column (YES in step S205), the electronic information terminal 10 performs the appropriate check on the input data in the page (step S206). In this example, the step where the electronic information terminal 10 determines whether the electronic information terminal 10 performs the appropriate check on the input data by the electronic information terminal 10 is omitted. However, as described in the above example, this step may also be executed. When determining that that the input item of the blank column is not necessary (essential) to be input (NO in step S203), as illustrated in part (c) of FIG. 5, though a message requesting the data input may be temporarily displayed, for example, after a predetermined time period has passed, the process goes to step S206 to determine whether the input data are appropriate (input data appropriateness determination step). The appropriate check in this example is performed based on a simple criterion. For example, it is determined whether the designated character type (e.g., one-byte characters) are used in the data input into the birthday column, and whether one of the designated years is input.

Then, as a result, when determining that the input data are appropriate (YES in step S206) and further determining that there is the next page available (YES in step S207), as illustrated in part (e) of FIG. 5, the second page of the standard format is displayed (step S208), and the process goes back to step S201. On the other hand, when determining that the input data are not appropriate (NO in step S206), an error message requesting the input of appropriate data is displayed on the display 11 (step S209). This error message is displayed until the next handwriting data are input (NO in step S210). When the next handwriting data are input (YES in step S210), the process goes back to step S206 and it is determined whether the input data input in step 210 are appropriate. Next, when there is no next page in the standard format (NO in step S207), the input data of all the pages are collectively transmitted to the server and the input operation in the standard format is completed (step S211). It is assumed that the input data are collectively transmitted to the server when the data transmission button 14 is pressed or when determining that all the input data are appropriate until the last page.

Next, another input operation is described. In this example, a case is described where the input item is necessary to be input and the page is not the last page.

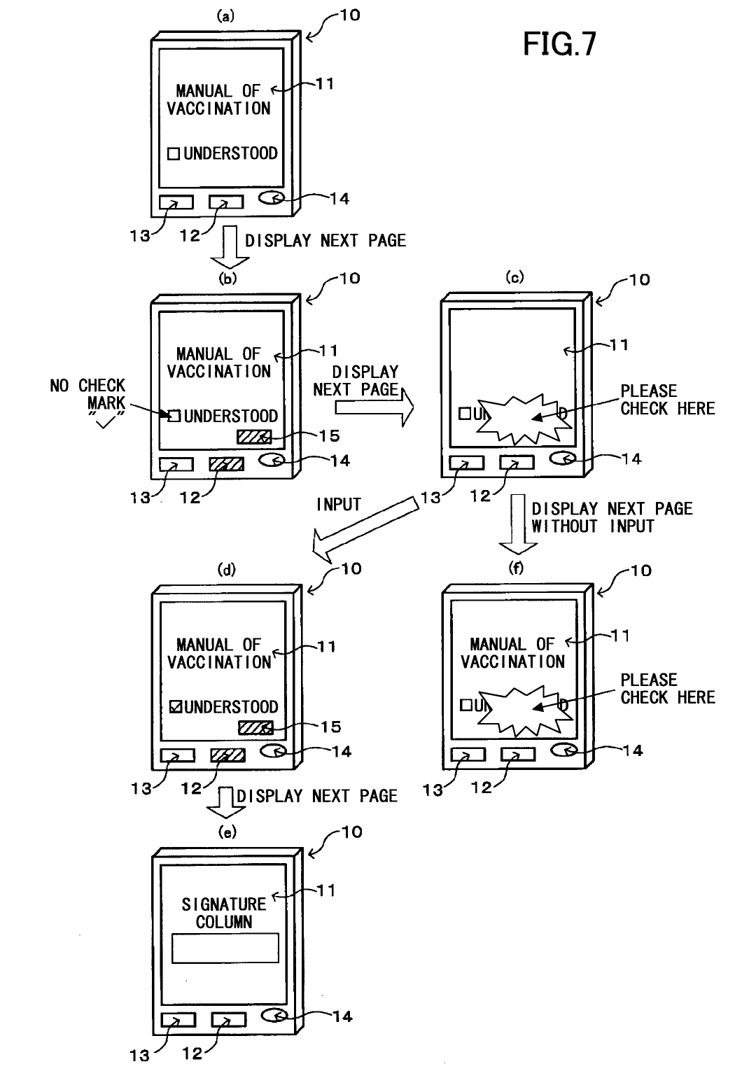

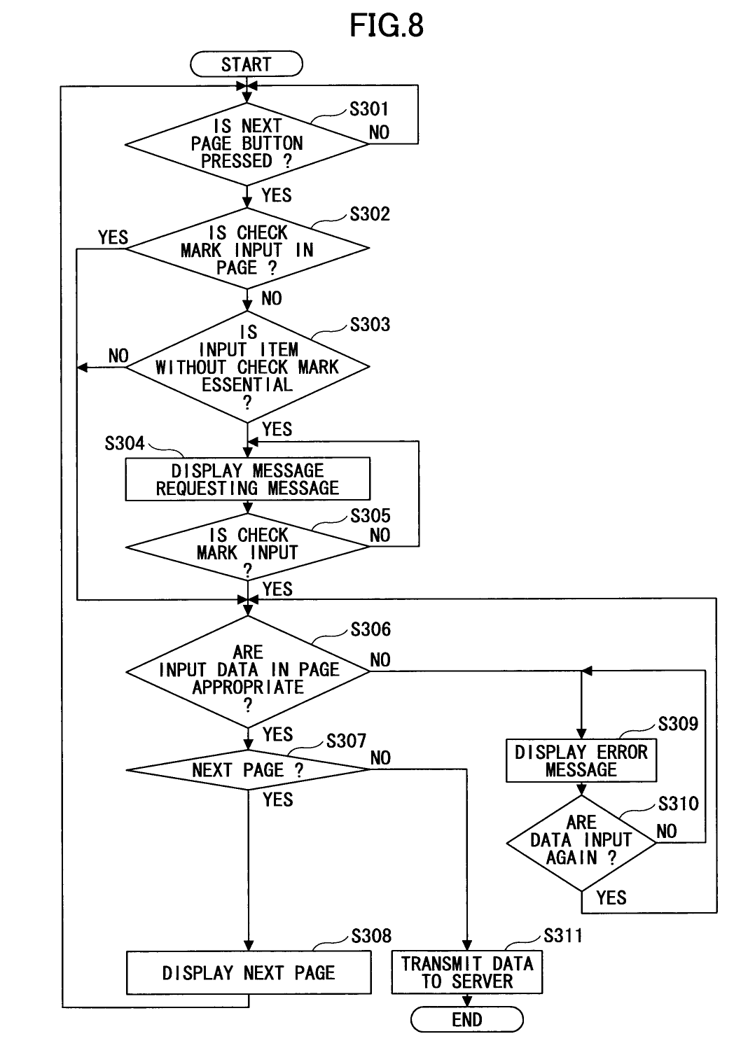

FIG. 7 schematically illustrates still another input operation of the electronic information terminal in this embodiment. FIG. 8 is a flowchart of the input operation of FIG. 7. First, as illustrated in part (a) of FIG. 7, the display 11 of the electronic information terminal 10 displays the first page of a standard format. In this example, a standard format of a manual of vaccination is displayed. In the first page of the standard format, a column where data indicating whether the content of the manual is understood is displayed for input. In this example as well, the electronic information terminal 10 does not monitor (determine) whether the handwriting data are input (written) in the predetermined column using the pen input means (not shown). Namely, as illustrated in part (b) of FIG. 7, the electronic information terminal 10 determines whether the next page button 12 or the next page display button 15 on the display 11 to be operated is pressed (touched) (step S301). When determined that the next page button 12 or the next page display button 15 is pressed (YES in step S301), the electronic information terminal 10 further determines whether the column where the check mark is to be placed is blank in the page (step S302). As a result, when determining that the column where the check mark is to be placed is blank (YES in step S302), it is determined weather the data item of the blank column is necessary to be filled with data (check mark) (step S303). When determining that the data item of the blank column is necessary to be filled with data (YES in step S303), a message requesting the data input as illustrated in part (c) of FIG. 7 is displayed until the check mark is input (placed) (step S304, NO in step S305). When the check mark is placed as illustrated in part (d) of FIG. 7, the electronic information terminal 10 performs the appropriate check on the input data in the page (step S306). In this example, the step where the electronic information terminal 10 determines whether the electronic information terminal 10 performs the appropriate check on the input data by the electronic information terminal 10 is omitted. However, as described in the above example, this step may also be executed. When determining that that the input item of the blank column is not necessary (essential) to be input (NO in step S303), the process goes to step S306 to determine whether the input data are appropriate (input data appropriateness determination step). The appropriate check in this example is performed based on a simple criterion. For example, it is determined whether handwriting data are written in a predetermined column and whether the handwriting data can be recognized as characters.

Then, as a result, when determining that the input data are appropriate (YES in step S306) and further determining that there is the next page available (YES in step S307), as illustrated in part (e) of FIG. 7, the second page of the standard format is displayed (step S308), and the process goes back to step S301. On the other hand, when determining that the input data are not appropriate (NO in step S306), an error message requesting the input of appropriate data is displayed on the display 11 (step S309). This error message is displayed until the next handwriting data are input (NO in step S310). When the next handwriting data are input (YES in step S310), the process goes back to step S306 and it is determined whether the input data input in step S310 are appropriate. Next, when there is no next page in the standard format (NO in step S307), the input data of all the pages are collectively transmitted to the server and the input operation in the standard format is completed (step S311). It is assumed that the input data are collectively transmitted to the server when the data transmission button (not shown) is pressed or when determining that all the input data are appropriate until the last page.

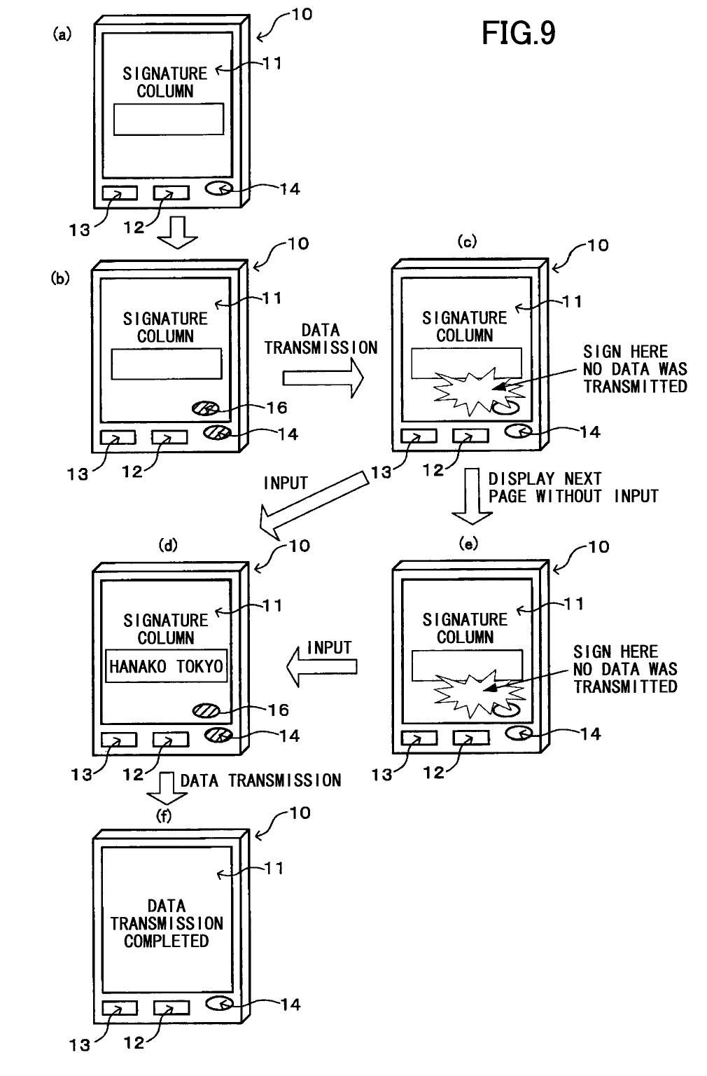

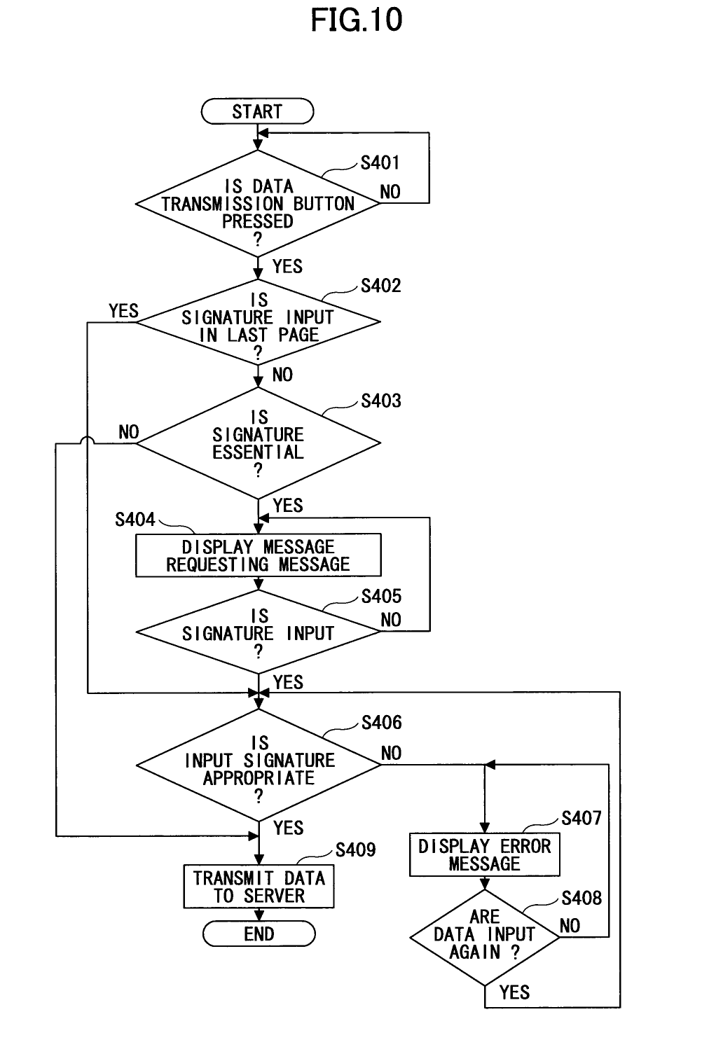

FIG. 9 schematically illustrates still another input operation of the electronic information terminal in this embodiment. FIG. 10 is a flowchart of the input operation of FIG. 9. As illustrated in part (a) of FIG. 9, in this example, an input operation to the signature column in the last page of a standard format is described. First, as illustrated in part (a) of FIG. 9, the display 11 of the electronic information terminal 10 displays the signature column where signature is input (written) in the last page. As illustrated in part (b) of FIG. 9, the electronic information terminal 10 determines whether the data transmission button 14 or a data transmission display button 16 displayed on the display 11 to be operated is pressed (touched) (step S401). When determined that the data transmission button 14 or the data transmission display button 16 is pressed (YES in step S401), the electronic information terminal 10 further determines whether the signature column is filled with data (step S402). As a result, when determining that the signature column is blank (NO in step S402), it is determined weather the blank column is necessary (essential) to be filled with a signature (step S403). When determining that the blank column is necessary to be filled with a signature (YES in step S403), a message requesting the signature input as illustrated in part (c) of FIG. 9 is displayed until signature is input (written) (step S404, NO in step S405). When a signature is input as illustrated in part (d) of FIG. 9, the electronic information terminal 10 performs the appropriate check on the input signature (step S406). In this example, the step where the electronic information terminal 10 determines whether the electronic information terminal 10 performs the appropriate check on the input data by the electronic information terminal 10 is omitted. However, as described in the above example, this step may also be executed. When determining that that the blank column is not necessary to be filled with a signature (NO in step S403), data are transmitted to the server (step S409). The appropriate check in this example is performed based on a simple criterion. For example, it is determined whether a handwriting signature is written in a predetermined column and whether the handwriting signature can be recognized as characters.

Then, as a result, when determining that the input data are appropriate (YES in step S406), as illustrated in part (e) of FIG. 9, data are transmitted to the server (step S409). On the other hand, when determining that the input data are not appropriate (NO in step S406), an error message requesting the input of appropriate data is displayed on the display 11 (step S407). This error message is displayed until the next handwriting data are input (NO in step S408). When the next handwriting data are input (YES in step S408), the process goes back to step S406 and it is determined whether the input data input in step S408 are appropriate. When determining that the input data input in step 408 are appropriate (YES in step S406), the data are transmitted to the server and the input operation in the standard format is completed (step S409).

Next, still another input operation is described. This input operation includes a process of selecting whether data is to be input.

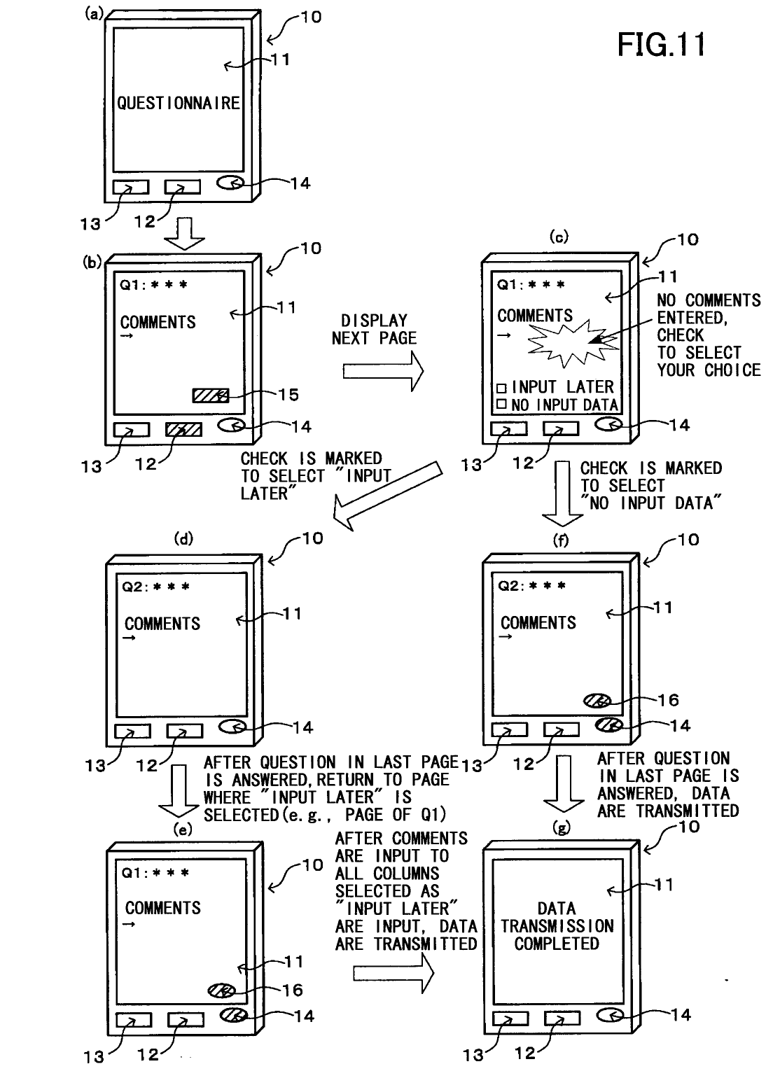

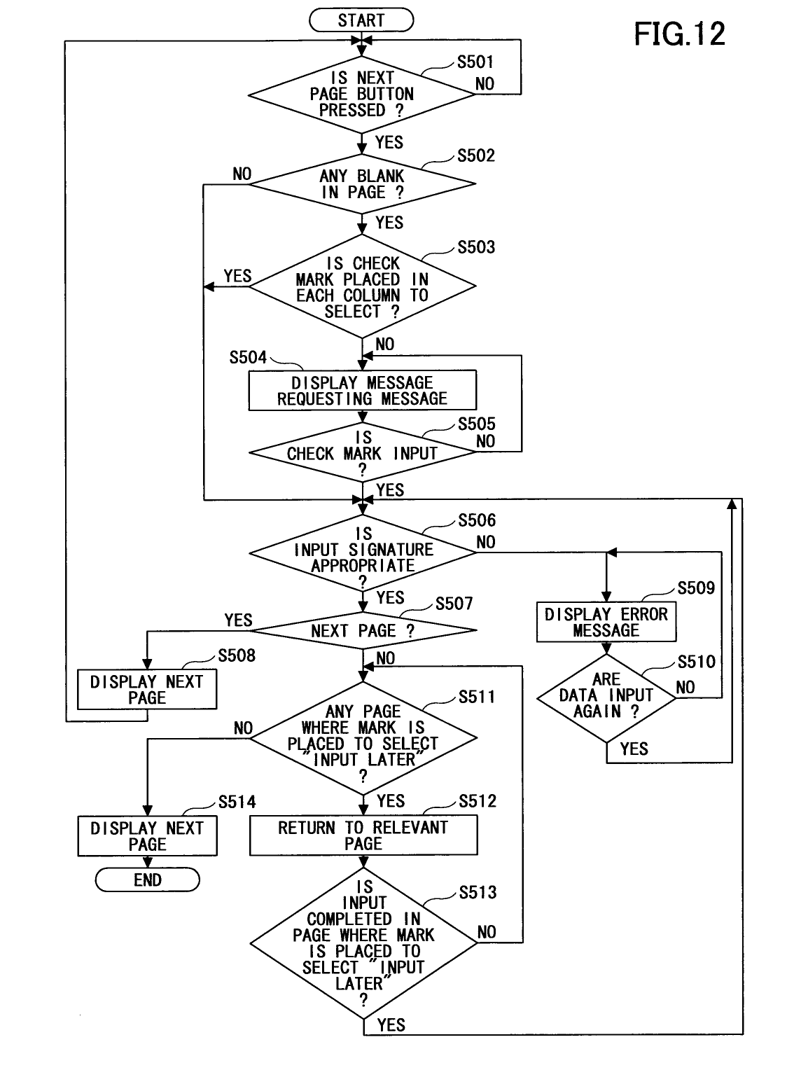

FIG. 11 schematically illustrates still another input operation of the electronic information terminal in this embodiment. FIG. 12 is a flowchart of the input operation of FIG. 10. As illustrated in part (a) of FIG. 11, the first page of the standard format is displayed on the display 11 of the electronic information terminal 10. In this example, the standard format has a questionnaire form. As the first page of this standard format, a question Q1 is displayed. In this example as well, the electronic information terminal 10 does not monitor (determine) whether the handwriting data are input (written) in the predetermined column using the pen input means (not shown). Namely, as illustrated in part (b) of FIG. 11, the electronic information terminal 10 monitors (determines) whether the next page button 12 or the next page display button 15 on the display 11 to be operated is pressed (touched) (step S501). When determined that the next page button 12 or the next page display button 15 is pressed (YES in step S501), the electronic information terminal 10 further determines whether the comment column for the question Q1 is blank (step S502). As a result, when determining that the comment column is blank (YES in step S502), it is determined weather the check mark is placed on either a check column indicating that the input to the comment column is performed later or a check column indicating that no data are input to the comment column (step S503). When determining that no check mark is placed (NO in step S503), as illustrated in part (c) of FIG. 11, a message requesting the input of the check mark is displayed until the check mark is placed (step S504, NO in step S505). As illustrated in part (d) of FIG. 11, when determining that the check mark is placed in any one of the check columns (YES in step S505), the electronic information terminal 10 performs the appropriate check on the input data of the input comments (step S506). In this example, the step where the electronic information terminal 10 determines whether the electronic information terminal 10 performs the appropriate check on the input data by the electronic information terminal 10 is omitted. However, as described in the above example, this step may also be executed. Then, for example, in this appropriate check, it is determined whether the input comments are input (written) in a predetermined input column. The appropriate check in this example is performed based on a simple criterion. For example, it is determined whether the number of characters (words) in the comments exceeds a predetermined upper limit number.

Then, as a result, when determining that the input data are appropriate (YES in step S506) and there is the next page available (YES in step S507), as illustrated in part (d) of FIG. 11, the question Q2 in the second page is displayed (step S508), and the process goes back to step S501. On the other hand, when determining that the comments (input data) are not appropriate (NO in step S506), an error message requesting the input of appropriate data is displayed on the display 11 (step S509). This error message is displayed until the next handwriting comments are input (NO in step S510). When the next handwriting comments are input (YES in step S510), the process goes back to step S506 and it is determined whether the input data input in step S510 are appropriate. When determining that the input data input in step S510 are appropriate (YES in step S506) and that there is no next page available (NO in step S507), it is determined whether there is a page where the check mark is placed in the column indicating that comments will be input (written) later (step S511). When determining that there is a page where the check mark is placed in the column indicating that comments will be input (written) later (YES in step S511), as illustrated in part (e) of FIG. 11, the relevant page is displayed (step S512). Then, it is determined where all the inputs of the comments in the page(s) where the check marks are placed in the columns indicating that comments will be input later is completed (step S513). When determining that all the inputs are completed (YES in step S513), the process goes back to step S506 and it is determined whether the input data are appropriate. When determining that the input data are appropriate (YES in step S506), the data are collectively transmitted to the server (step S514) and the input operation in the standard format is completed.

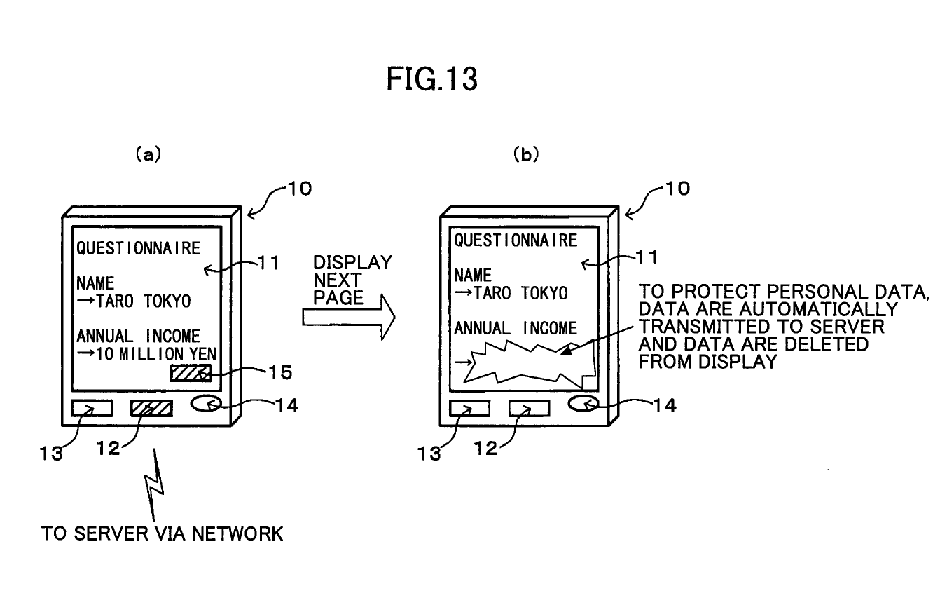

FIG. 13 schematically illustrates still another input operation of the electronic information terminal in this embodiment. In this input operation, the input data to respond to the questionnaire are personal data to be protected when, for example, the question is about the user's annual income. In this example, first, a questionnaire form of the standard format is displayed on the display 11 of the electronic information terminal 10. Then, data corresponding to predetermined input items are input and the next page button 12 or the next page display button 15 is pressed. In this case, when the input items include the input item where personal data are to be input, so that, for example, the amount of annual income is input to respond to the question asking about the annual income, the personal data may be transmitted to the server and the input data indicating the annual income in this case are stored in either the server or the electronic information terminal. Further, the input data are deleted on display. In this case, for example, a message “To protect personal data, input data are automatically transmitted to the server and deleted from display” may be displayed.

As described above, according to an embodiment of the present invention, as illustrated in FIG. 1, the electronic information terminal 10 in includes a main controller, a storage, a display section, an input section, and a communication controller such as an interface to establish communications with the server as main elements. The display section includes the display 11 having the memory function. Further, the display section has the function to input handwriting characters using an input means such as a digitizer pen. The electronic information terminal 10 further includes the next page button 12, the previous page button 13, and the data transmission button 14. The next page button 12 and the previous page button 13 are used to display the next page and the previous page, respectively, of the standard format. By having the elements, the standard format can be display page by page on the screen of the display 11, so that data corresponding to the input items of the standard format can be input via the input section. Further, when the next page button 12 is pressed, it is determined whether input data corresponding to the data items are appropriate. Otherwise, the input data are transmitted to the server, so that the server determines whether the input data are appropriate. As a result, upon determining that the input data are appropriate, the next page is displayed. Further, when the data transmission button 14 is pressed, all the input data having been determined as appropriate are transmitted to the server. Because of the data transmission method, the input data of all the pages including the page having the input data determined as appropriate are not collectively transmitted to the server. As a result, it may become possible to reduce the workloads of the server and the network. Further, when the next page displayed and when the input data are transmitted, it is already determined (confirmed) that the input data are appropriate. Because of this feature, it becomes no longer necessary to review the input data again (to correct the input data). As a result, it may become possible to improve the operability of the electronic information terminal.

Further, according to an embodiment of the present invention, as illustrated in FIG. 9, it is possible to input handwriting data via the display 11. After the handwriting data corresponding to the input item of the standard format are input (written), when the next page button 12 or the data transmission button 14 (the data transmission display button 16) is pressed, it is determined whether the input data of the handwriting data are appropriate. Only when determining (confirming) that the input data of the handwriting data are appropriate, the next page is displayed or the input data are transmitted to the server. In other words, when the next page is displayed or the input data are transmitted to the server, it is already determined (confirmed) that the input data are appropriate. Because of this feature, it becomes no longer necessary to review the input data again (to correct the input data). As a result, it may become possible to improve the operability of the electronic information terminal.

Further, according to an embodiment of the present invention, the process of determining whether the input data are appropriate is mainly performed by the electronic information terminal. However, depending on the case, the process may be performed by the server. when the input data correspond to the inspection data, more specifically, for example, when the data amount of the input data is relatively small or when processes to be performed on the input data are relatively simple (easy), the electronic information terminal performs the appropriate check on the input data (i.e., it is determines whether the input data are appropriate by the electronic information terminal). On the other hand, when the input data correspond to the attached data, more specifically, for example, when the data amount of the input data is relatively large or when processes to be performed on the input data are relatively complicated, the server performs the appropriate check on the input data (i.e., it is determines whether the input data are appropriate by the server). Because of this feature, it may become possible to reduce the workloads of the server and the network.

Further, according to an embodiment of the present invention, as illustrated in FIGS. 5, 7, 9, and 11, in a case where the next page button 12 or the data transmission button 14 is pressed, if there are the input data having been determined as inappropriate, a corresponding error message is displayed on the display 11. Further, it is possible to check the data to be corrected and the input item having data to be corrected on the page. Therefore, it may become possible to correct the input data easily and ensure to input correct data.

According to an embodiment of the present invention, as illustrated in FIG. 8, it is determined whether the input item is necessary to be filled with data. Then, when determining that the input item is necessary to be filled with data, as illustrated in FIG. 9, a message requesting the input of the input data corresponding to the input item is displayed on the display 11. Only when the input data corresponding to the input item are input and it is determined that the input data are appropriate, the next page is displayed or the input data are transmitted to the server. Therefore, it may become possible to prevent the transmission of erroneous data. As a result, it may become possible to improve the operability of the electronic information terminal.

Further, according to an embodiment of the present invention, as illustrated in FIG. 11, the standard format includes a column where it is possible to select whether input data corresponding to the input item will be input. In a case where the next page button 12 or the data transmission button 14 is pressed, when it is selected in the column that input data corresponding to the input item will not be input in a predetermined column, the next page is displayed or data are transmitted to the server. In a case where the next page button 12 or the data transmission button 14 is pressed and it is selected in the column that input data corresponding to the input item will be input, only when the input data are input into the predetermined column and it is determined that the input data are appropriate, the next page is displayed or the data are transmitted to the server. Because of this feature, it may become possible to provide a versatile electronic information terminal.

Further, according to an embodiment of the present invention, when the input data input to the input items corresponds to personal data, the input data are stored in the storage of the electronic information terminal or transmitted to the server so that the sever manages the input data. Further, the input data corresponding to personal data are deleted from the display 11. As a result, the personal data may be protected and the electronic information terminal having improved operability may be provided.

The present invention is described by referring to a specific embodiment. However, a person skilled in the art may understand that the above embodiment is described for illustrative purpose only and may think of examples of various modifications, transformations, alterations, changes, and the like. For illustrative purposes, the apparatus according to an embodiment of the present invention is described with reference to the functional block diagrams. However, such an apparatus may be provided by hardware, software, or a combination thereof. The present invention is not limited to the embodiment described above, and various modifications, transformations, alteration, exchanges, and the like may be made without departing from the scope and spirit of the present invention.

The present application is based on and claims the benefit of priority of Japanese Patent Application No. 2010-293963, filed on Dec. 28, 2010, the entire contents of which are hereby incorporated herein by reference.

1. An electronic information terminal including a main controller collectively controlling the entire electronic information terminal, a storage, a display unit, an input unit, and a communication controller establishing a communication network with a server, the electronic information terminal comprising:
either an appropriateness determination unit or a transmission and receiving unit,
the appropriateness determination unit being configured to determine whether input data are appropriate, the input data being input by the input unit and corresponding to an input item of a standard format,
the transmission and receiving unit being configured to transmit the input data to the server and receive an appropriateness determination result of the input data from the server;
a next page instruction unit configured to instruct to display a next page of the standard format including one or more pages; and
a data transmission instruction unit configured to instruct to transmit the input data to the server using the communication controller,
wherein when the next page instruction unit instructs to display the next page, either the appropriateness determination unit is configured to determine whether all the input data are appropriate, the input data being displayed on a screen in a page of the standard format, or the transmission and receiving unit is configured to transmit the input data to the server and receive the appropriateness determination result of the input data from the server, so that, when determining that all the input data displayed on the page are appropriate, the next page is displayed if the next page is available, and
wherein, when there is no next page and the next page instruction unit instructs to display the next page, either all the input data of all the pages are transmitted to the server and data input to the standard format is completed, the input data having been determined as appropriate by the appropriateness determination unit, or the input data corresponding to the input items of the page displayed on the display unit when the next page instruction unit instructs to display the next page are transmitted to the server by the transmission and receiving unit and when determining that the input data are appropriate based on the appropriateness determination result received from the server, data input to the standard format is completed.

2. The electronic information terminal according to claim 1,
wherein the electronic information terminal includes
the appropriateness determination unit configured to determine whether input data are appropriate, the input data being input by the input unit and corresponding to the input item of the standard format,
the transmission and receiving unit configured to transmit the input data to the server and receive the appropriateness determination result of the input data from the server, and
a determination unit configured to determine whether the input data are to be determined whether the input data are appropriate using the appropriateness determination unit or the input data are to be transmitted to the server by the transmission and receiving unit so that the appropriateness determination result of the input data is received from the server.

3. An electronic information terminal including a main controller collectively controlling the entire electronic information terminal, a storage, a display unit, an input unit, and a communication controller establishing a communication network with a server, the electronic information terminal comprising:
an appropriateness determination unit configured to determine whether input data are appropriate, the input data being input by the input unit and corresponding to an input item of a standard format,
a transmission and receiving unit configured to transmit the input data to the server and receive an appropriateness determination result of the input data from the server;
a next page instruction unit configured to instruct to display a next page of the standard format including one or more pages; and
a data transmission instruction unit configured to instruct to transmit the input data to the server using the communication controller,
wherein when the next page instruction unit instructs to display the next page, the appropriateness determination unit is configured to determine whether all the input data are appropriate, the input data being displayed on a screen in a page of the standard format, or when the appropriateness determination unit cannot determine whether the input data are appropriate, the input data are transmitted to the server by the transmission and receiving unit and the appropriateness determination result of the input data is received from the server, so that, when determining that all the input data displayed on the page are appropriate, the next page is displayed if the next page is available, and
wherein, when there is no next page and the next page instruction unit instructs to display the next page, all the input data of all the pages are transmitted to the server and data input to the standard format is completed, the input data having been determined as appropriate by the appropriateness determination unit, and when the appropriateness determination unit cannot determine whether the input data are appropriate, the input data corresponding to the input item of the page displayed on the display unit when the data transmission instruction unit instructs to transmit the input data, the input data are transmitted to the server by the transmission and receiving unit, and when determining that the input data are appropriate based on the appropriateness determination result received from the server, the data input to the standard format is completed.

4. The electronic information terminal according to claim 3, further comprising:
a determination unit configured to determine whether the input data are to be determined whether the input data are appropriate using the appropriateness determination unit or the input data are to be transmitted to the server by the transmission and receiving unit so that the appropriateness determination result of the input data is received from the server.

5. The electronic information terminal according to claim 2,
wherein the determination unit is configured to determine that determination whether the input data are appropriate is to be performed by the appropriateness determination unit when the input data correspond to inspection data and that the input data are transmitted to the server so that the appropriateness determination result of the input data is received from the server.

6. The electronic information terminal according to claim 5,
wherein the inspection data correspond to data having a relatively small data amount or data on which an easy process is performed of determining whether data are input, determining whether a check mark is placed, whether the number of check marks exceeds a predetermined number, or whether a character type of the input data is appropriate.

7. he electronic information terminal according to claim 5,
wherein the attached data correspond to data having a relatively large data amount or data on which a complicated process is performed of determining appropriateness of image data including handwriting characters, stroke data including handwriting characters, the input data outside a column, image data including an input symbol, or date data.

8. The electronic information terminal according to claim 1,
wherein when a determination result by the appropriateness determination unit and the appropriateness determination result received by the transmission and receiving unit indicate that the input data are not appropriate, the display unit is configured to display an error message.

9. The electronic information terminal according to claim 1, further comprising:
an essentiality determination unit configured to determine whether the input item is necessary to be filled with data when data corresponding to an input item of the standard format are not input and either the next page instruction unit instructs to display the next page or the data transmission instruction unit instructs to transmit the input data,
wherein when the essentiality determination unit determines that the input item is necessary to be filled with data, the display unit is configured to display a message requesting data input to the input item.

10. The electronic information terminal according to claim 1,
wherein the data transmission instruction unit is configured to transmit the input data in a case where the next page instruction unit instructs to display the next page or the data transmission instruction unit instructs to transmit the input data based on the instruction to display the next page or the instruction to transmit the input data, respectively, when an instruction to select an option not to input data is input to a predetermined column indicating whether data corresponding to the input item is input or when an instruction to select an option to input data is input to a predetermined column and corresponding data are input and determined that the corresponding data are appropriate by the appropriateness determination unit or it is determined that the input data are appropriate based on the appropriateness determination result received from the server by the transmission and receiving unit.

11. The electronic information terminal according to claim 1,
wherein when the input data correspond to personal data, the input data are stored in the storage or transmitted to the server by the communication controller, and the input data are deleted from the display unit.

12. The electronic information terminal according to claim 1,
wherein the display section includes a display having a memory function.

13. The electronic information terminal according to claim 1,
wherein the display unit inputs handwriting data.

14. An electronic information system comprising:
the electronic information terminal according to claim 1; and
a server in communication with the electronic information terminal with a network.
